(19) United States
(12) Patent Application Publication
(10) Pub. No.: US 2017/0193550 A1
(43) Pub. Date: Jul. 6, 2017

(54) SYSTEMS AND METHODS FOR GENERATING TRAVEL RECOMMENDATIONS

(71) Applicant: MasterCard International Incorporated, Purchase, NY (US)

(72) Inventors: Sukanyya Misra, Gurgaon (IN); Qian Wang, Ridgefield, CT (US); Jeremy Michael Pastore, Brooklyn, NY (US); Matthew Haisley, Monroe, NY (US)

(21) Appl. No.: 14/984,559

(22) Filed: Dec. 30, 2015

(51) Int. Cl. G06Q 30/02; G06Q 10/02

(52) U.S. Cl. CPC G06Q 30/0255; G06Q 10/02

(57) ABSTRACT

Systems and methods for recommending merchants at a travel destination of a cardholder are provided. A travel analyzing computing system may include a retriever configured to obtain transaction data including addendum data from a travel-based transaction of a cardholder, an analyzer configured to analyze the addendum data and extract a travel destination of the cardholder from the addendum data, a categorizer configured to determine a spending category of the cardholder, from among a plurality of spending categories, based upon historical transaction data of the cardholder, and a processor configured to recommend one or more merchants to the cardholder based upon the extracted travel destination and the determined spending category of the cardholder.

### BACKGROUND

The present application relates generally to providing travel recommendations, and more particularly, to a network-based system and method for providing recommendations of merchants that are located at a travel destination of a selected cardholder based upon spending habits of the selected cardholder and interests of other cardholders having spending habits similar to the selected cardholder.

According to the U.S. Travel Association, domestic and international travelers that traveled within the United States during 2014 spent approximately $645 billion. It is further estimated that U.S. residents logged over 2.1 billion trips in 2014. Of those trips, about three out of four were taken for purposes of leisure. While traveling for leisure, top travel activities for U.S. domestic travelers include visiting relatives, shopping, visiting friends, dining, and going to the beach. Furthermore, while business travel represents about one fourth of domestic travel trips, it is estimated that direct spending as a result of business travel, including expenditures on meetings, events, and incentive programs, totaled approximately $283 billion in 2014. The five industries in which travel generated the most spending are food services, lodging, public transportation, auto transportation, and retail.

Prior to or during travel, a traveler may attempt to gather information about the travel destination. For example, a traveler might ask people they trust for recommendations, such as friends and/or family members who have previously traveled to the destination. However, the information the traveler receives from friends and family may not be reliable because the friends or family members may not accurately remember the information. Also, the recommendations may not be of interest to the traveler because the friends or family members may have different interests or spending habits in comparison to the traveler.

In an effort to provide travelers with information about their upcoming trip, various websites have been created. For example, travel sites such as TRIP ADVISOR®, TRAVELOCITY®, ORBITZ®, EXPEDIA®, HOTWIRE®, and KAYAK®, as well as many others, provide travelers with hotel, flight, and/or rental car pricing information, as well as reviews of hotels, airlines, rental cars, and the like. In these known cases, the review of various travel related businesses are provided by random users of the travel site. That is, anyone can post a review and the review is typically viewable by all who visit the site. However, these sites are frequented by a wide range of travelers that have a variety of spending habits and interests. Therefore, the reviews may or may not be relevant to the interests and spending habits of a particular traveler visiting the site.

Accordingly, a system is needed that provides a traveler with travel information and/or travel recommendations that are specifically targeted to and relevant to the specific traveler.

### BRIEF DESCRIPTION OF THE DISCLOSURE

In one aspect, a travel analyzing computing device is provided, the travel analyzing computing device including a retriever configured to obtain transaction data including addendum data from a travel-based transaction of a cardholder, an analyzer configured to analyze the addendum data and extract a travel destination of the cardholder from the addendum data, a categorizer configured to determine a spending category of the cardholder, from among a plurality of spending categories, based upon historical transaction data of the cardholder, and a processor configured to recommend one or more merchants to the cardholder based upon the extracted travel destination and the determined spending category of the cardholder.

In another aspect, a computer-implemented method for recommending merchants located near a travel destination of a cardholder is provided. The method is implemented by a travel analyzing computing device. The method includes: obtaining transaction data including addendum data from a travel-based transaction of a cardholder, analyzing the addendum data and extracting a travel destination of the cardholder from the addendum data, determining a spending category of the cardholder from among a plurality of spending categories based upon historical transaction data of the cardholder, and recommending one or more merchants to the cardholder based upon the extracted travel destination and the determined spending category of the cardholder.

In another aspect, a non-transitory computer-readable storage media having computer-executable instructions embodied thereon is provided. When executed by at least one processor, the computer-executable instructions cause the at least one processor to: obtain transaction data including addendum data from a travel-based transaction of a cardholder, analyze the addendum data and extract a travel destination of the cardholder from the addendum data, determine a spending category of the cardholder from among a plurality of spending categories based upon historical transaction data of the cardholder, and recommend one or more merchants based upon the extracted travel destination and the determined spending category of the cardholder.

### BRIEF DESCRIPTION OF THE DRAWINGS

FIG. 1 is a schematic diagram illustrating an example of a multi-party transaction card industry system for authorizing payment card transactions in which parties provide processing services to various financial entities, in accordance with an example embodiment of the present disclosure.

FIG. 2 is a diagram illustrating a recommendation system including a cardholder, a merchant, a payment processor, an issuer, and a travel analyzer, in accordance with an example embodiment of the present disclosure.

FIG. 3 is a diagram illustrating an example of a travel analyzing computing device that may be included in the recommendation system of FIG. 1, in accordance with an example embodiment of the present disclosure.

FIG. 4 is a diagram illustrating an example of a cardholder computing device that may be used by the user included in the travel recommendation system of FIG. 1, in accordance with an example embodiment of the present disclosure.

FIG. 5 is a diagram illustrating an example of a method of a travel analyzing computing device providing travel recommendations to a user, in accordance with an example embodiment of the present disclosure.

### DETAILED DESCRIPTION OF THE DISCLOSURE

Travelers rely on a variety of travel sites and recommendation engines to assist with travel planning. However, these websites and applications are typically blunt tools in which anonymous strangers offer advice to a general audience, without knowing a particular traveler's spending habits or lifestyle. According to various aspects described herein, travel recommendations may be provided to a cardholder based upon spending habits of the cardholder and based upon a travel destination of the cardholder. The travel destination of the cardholder may be extracted from addendum data included within a transaction message of a travel-based transaction. The spending habits of the cardholder may be based upon historical transaction data of the cardholder including previous purchases made by the cardholder and/or the addendum data included in the transactions.

That is, rather than provide general recommendations for a general audience, exemplary embodiments provide recommendations targeted to a cardholder based upon the spending habits of the cardholder and based upon the spending habits and interests of other cardholder with a same spending category type as the cardholder. In addition, the other cardholders may also have travelled to a destination, or live at the destination, in which the cardholder is planning to travel to, or is currently visiting. Based upon current and/or previous spending habits, a cardholder may be categorized as (i) a business traveler, such as someone who makes a great deal of airline and hotel purchases, (ii) a family traveler who spends money on children's activities and at merchants dedicated to children, (iii) a corporate traveler who likes to entertain clients at restaurants and events, and the like. The example embodiments herein describe a recommendation system that may consider the spending habits of similar cardholders when recommending merchants because cardholders having similar spending habits are likely to enjoy similar types of merchants.

According to various examples herein, a financial entity, such as a bank, a payment processor, and the like, may provide a traveler (e.g., traveling cardholder) with guidance for smart vacation planning because the financial entity has access to spending information about a cardholder. For example, a payment processor may have data that, when analyzed, can determine what different types of cardholders do when they are present at a vacation location, business travel destination, and the like. When a transaction occurs, such as a transaction associated with a debit card, credit card, loyalty card, rewards card, and the like, (collectively a “payment card”) data about the transaction, item or items purchased, the merchant, the cardholder, and the like, may be generated and stored. According to various aspects, a recommendation engine may model the spending history of a cardholder and may offer advice targeted toward the spending habits of the cardholder based upon other cardholders with similar spending habits.

A financial transaction typically includes an authorization process, a settlement process, and clearing process. During the authorization, an initial payment amount is processed to determine whether the cardholder has sufficient funds to cover the initial payment amount. At this point, a financial entity processing the transaction, for example, a payment processor, a bank, and the like, may receive data about the transaction, such as merchant name, purchase amount, and the like. This data is referred to as authorization data.

The authorization data may include basic data about the transaction that is needed to authorize the transaction. However, according to various aspects herein, additional data may be added to the transaction, for example, during the clearing process and/or during the authorization process. This additional data, also referred to as addendum data, may be added by a merchant, a bank, a payment processor, and the like. The addendum data may be analyzed to determine additional details about a cardholder and about items purchased by a cardholder. For example, when a cardholder makes a purchase such as an airline ticket, authorization data of the purchased airline ticket may include the airline merchant name or ID, the amount of the purchase, the time of the purchase, and the like. During the clearing process, addendum data may be added to the airline transaction. In the example of an airline ticket transaction, the addendum data may further include a departure location, a destination location, type of ticket purchased (e.g., coach, first class, business class, etc.) flight itinerary, flight number, flight time, and the like. That is, the addendum data may include additional data about the flight purchased that may not be available from the authorization data.

As another example, addendum data may be attached to a rental car transaction, a hotel booking transaction, and the like. For example, the addendum data added to a rental car transaction may include pickup and drop-off locations, miles driven, insurance type, corporate flag, tax exemption flag and rental class. As another example, addendum data added to a hotel booking transaction or other lodging transaction may include hotel charges for restaurants, bars, spas, fitness centers and event-related charges, such as for banquet halls, business centers and conference rooms. Here, a hotel may refer to any type of lodging, for example, hotels, motels, bed and breakfasts, inns, and the like.

According to various examples herein, a computing device with access to transaction information or that receives the transaction information, for example, a computing device associated with a bank or a payment processor, may use addendum data of a transaction or addendum data of multiple transactions to generate spending information about a cardholder. According to various examples, the generated spending information may include a spending category of the cardholder indicating the spending habits of the cardholder. In addition to, or instead of the authorization data of the transaction, the spending information may be based upon the addendum data which may be added to a transaction during the clearing process. The addendum data may include more granular data than what is included in the authorization data. As an example, the addendum data may include additional details about an item purchased by the transaction. Here, an item may refer to a good and/or a service. For example, an item may include a plane ticket, a rental car, a hotel booking, and the like.

The travel analyzing system may determine or may store a plurality of spending categories of cardholders. For example, based upon the general spending habits of all cardholders, a plurality of spending categories for the cardholders may be generated. Using historical transaction data of the traveling cardholder, the computing device may also determine a spending category of the traveling cardholder from among the stored plurality of spending categories. That is, the spending category of the traveling cardholder may be determined as the spending category from among the plurality of spending categories (based upon all cardholders) that most closely matches the spending habits of the traveling cardholder.

The system may also detect or extract a travel destination of the cardholder based upon the addendum data. Accordingly, the computing device may recommend merchant locations at the travel destination to the cardholder based upon the detected travel destination that is included in a travel-based transaction. In some cases, the spending category may be generated based upon additional transactions made by the cardholder as well as the travel-based transaction. As another example, the spending category of a cardholder may be generated based upon prior purchases not including the travel-based transaction.

A cardholder may make any number of travel-based purchases in preparation for or while traveling. As described herein, travel may refer to business travel, a vacation, personal travel, corporate travel, and the like. The spending category of a cardholder may be determined based upon historical transactions, for example, travel-based transactions made for future travel, travel-based transactions incurred during previous travel, all types of transactions in addition to travel-based transactions, transactions incurred over a predetermined period of time, and the like. Accordingly, a spending category of a cardholder may be determined based upon travel-based transactions made by the cardholder for an upcoming vacation, such as hotel lodging, airline purchases, car rental purchases, and the like. As another example, the spending category of the cardholder may be based upon data from a current travel-based transaction added together with data from previous transactions of the cardholder, or based only upon the previous transactions.

The recommendations provided to the cardholder may be made in response to one or more travel-based transactions completing a clearing process. An authorization for a transaction typically occurs immediately or within a few minutes of a purchase, however, a clearing process or “clearing” may take additional time, for example, until the end of a business day, 12-hours, 24-hours, 2 days, 3 days, and the like. According to various aspects, during the clearing process, addendum data may be added to a transaction. The addendum data may include finer (i.e., more granular) details about the items included in the travel-based transaction in comparison to the data included in the authorization process and/or the settlement process of the travel-based transaction.

In addition, based upon information included in the addendum data of a travel-based transaction, the computing device may determine a duration of travel of a cardholder, a time at which the cardholder is arriving at the travel destination, a location of a holdover or layover, how many people are travelling with the cardholder, and the like. Accordingly, the travel analyzing computing device may analyze the addendum data and provide recommendations of merchants and/or activities to a cardholder that are more relevant to the cardholder at the time and place of travel during the course of travel.

The recommendations may be provided to a cardholder automatically, for example, the computing device may control a cardholder device to display the recommendations. In this example, the cardholder device may be a mobile device that has installed therein and/or is executing a mobile application corresponding to the recommendation system. As another example, the cardholder may receive the recommendations through an e-mail, the mail, a phone call, and the like. Because a cardholder typically makes travel reservations and travel-based purchases a few weeks to a few months in advance, the travel recommending system may provide the recommendations at various times, for example, at a time at which the travel-based transaction finishes clearing, at a predetermined time before the travel occurs, while the cardholder is travelling, and the like. Also, because a cardholder typically makes travel reservations and travel-based purchases a few weeks to a few months in advance, even if clearing takes a day or two, the system may be able to provide the cardholder with recommendations prior to travelling.

In various examples herein, the travel analyzing computing device might suggest merchants to a cardholder based upon merchants of interest to other cardholders that are included in a same spending category type as the cardholder. For example, the computing device may determine a travel destination of the cardholder based upon the addendum data. Also, the computing device may determine, or may have previously determined a spending category type to which the cardholder belongs based on historical transaction data. The computing device may analyze the spending behavior of other cardholders that have the same spending category type as the cardholder and who have also visited the travel destination location, or who live at the travel destination location, and recommend merchants based upon the analyzing. For example, if a spending category type of the cardholder is a family vacationer, the computing device may provide family vacation type merchants at the travel destination to the cardholder that are the most popular with other cardholders having family vacationer spending habits.

As another example, the travel analyzing computing device may recommend merchants to the cardholder based upon a merchant type that is tied to a spending category type of the cardholder. Here, a merchant type may be linked to a particular spending category type. As a non-limiting example, a four-star restaurant may be linked to a corporate type spending category. In this case, a merchant of the merchant type tied to the spending category and which is most popular with all types of cardholders, and not just those cardholders included in the same spending category, may be suggested to the cardholder. As another example, a merchant of that type that has a location that is closest to a location at which the cardholder will be staying or is currently staying, from among the plurality of merchants of that type, may be suggested to the cardholder.

### Example of Payment Card Transaction Network

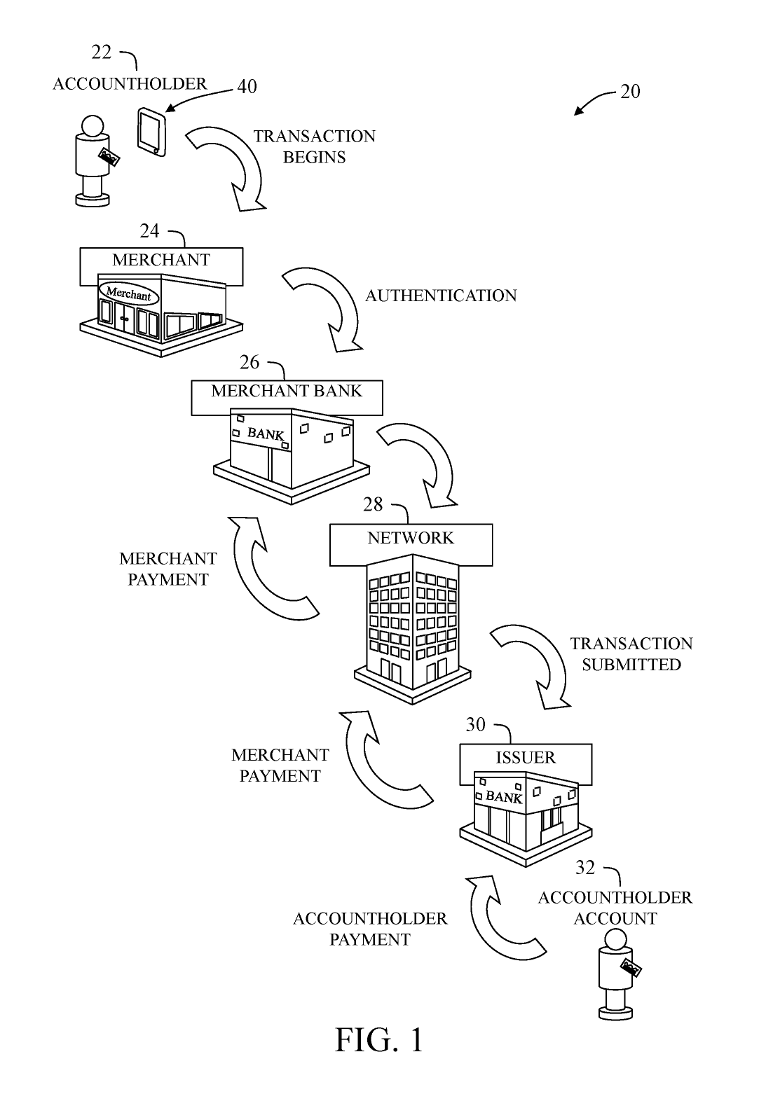

FIG. 1 is a schematic diagram illustrating an example multi-party transaction card industry system 20 for authorizing payment card transactions in which parties provide processing services to various financial entities. Embodiments described herein may relate to a transaction card system, such as a payment card payment system using the MasterCard® interchange network. The MasterCard® interchange network is a set of proprietary communications standards promulgated by MasterCard International Incorporated for the exchange of financial transaction data and the settlement of funds between financial institutions that are members of MasterCard International Incorporated. (MasterCard is a registered trademark of MasterCard International Incorporated located in Purchase, N.Y.).

In a typical transaction card system, a financial institution referred to as the “issuer” issues a transaction card, such as a credit card, debit card, and the like, to the consumer or account holder 22, who uses the transaction card to tender payment for a purchase from merchant 24. To accept payment with the transaction card, merchant 24 normally establishes an account with a financial institution that is part of the financial payment system. This financial institution is referred to as the “merchant bank,” the “acquiring bank,” or the “acquirer.” In one embodiment, account holder 22, also referred to as cardholder, tenders payment for a purchase using a transaction card at a transaction processing device 40 (e.g., a point of sale device), and merchant 24 then requests authorization from a merchant bank 26 for the amount of the purchase. The request is usually performed through the use of a point-of-sale terminal, which reads account information from a magnetic stripe, a chip, embossed characters, and the like, included on the transaction card of the account holder 22 and communicates electronically with the transaction processing computers of merchant bank 26. Alternatively, merchant bank 26 may authorize a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 or merchant processor may communicate with computers of an issuer bank 30 to determine whether account 32 of account holder 22 is in good standing and whether the purchase is covered by an available credit line of the account 32 corresponding to account holder 22. Based on these determinations, the request for authorization may be declined or accepted. If the request is accepted, an authorization code may be issued to merchant 24.

When a request for authorization is accepted, the available credit line of the account holder 22 is decreased, that is, account 32 is decreased. A charge for a payment card transaction may not be posted immediately to account 32 of the account holder 22 because payment networks, such as MasterCard International Incorporated, may have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If account holder 22 cancels a transaction before it is captured, a “void” is generated. If account holder 22 returns goods after the transaction has been captured, a “chargeback” is generated. Interchange network 28 and/or issuer bank 30 stores the transaction card information, such as a type of merchant, amount of purchase, date of purchase, in a database.

After a purchase has been made, a clearing process occurs to transfer additional transaction data related to the purchase among the parties to the transaction, such as merchant bank 26, interchange network 28, and issuer bank 30. According to various aspects herein, during the clearing process, additional data (i.e., addendum data), may be added to the transaction. Accordingly, addendum data may be associated with a transaction and transmitted between parties to the transaction as transaction data, and may be stored by any of the parties to the transaction.

After a transaction is authorized and cleared, the transaction may be settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1, such as, for example, account holder 22, merchant 24, merchant bank 26, interchange network 28 (also referred to as payment processor), and issuer bank 30. In the additional examples herein, a traveler, traveling cardholder, etc., may also correspond to the account holder 22 illustrated in FIG. 1.

### Example of a Recommendation System

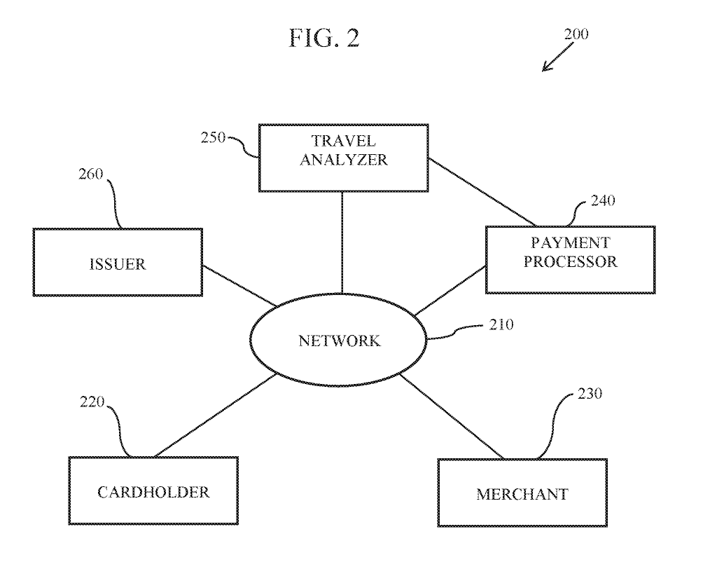

FIG. 2 is a diagram illustrating a recommendation system including a cardholder, a merchant, a payment processor, an issuer, and a travel analyzer, in accordance with an example embodiment of the present disclosure.

Referring to FIG. 2, recommendation system 200 includes computing devices that respectively represent a cardholder 220, a merchant 230, a payment processor 240, a travel analyzer 250, and an issuing bank (“issuer”) 260 which are connected to each other via network 210. Network 210 may include the Internet and/or one or more other networks. For example, a connection between the computing devices may include a wireless network, a wired network, a telephone network, a cable network, a combination thereof, and the like. Examples of a wireless network include networks such as WiFi, WiMAX, WiBro, LAN, PAN, MAN, cellular, Bluetooth, and the like.

Cardholder 220 may be a computing device, for example, a mobile phone, a smart phone, a telephone, a computer, a laptop, a desktop, a tablet, an MP3 player, a digital assistant, a server, and the like. Cardholder 220 may access a website that corresponds to the merchant 230 or that is hosted by merchant 230, may contact a phone number of merchant 230, and the like. For example, using cardholder computing device 220, a cardholder may access a travel site and make a purchase from merchant 230. As an example, merchant 230 may be a travel-based merchant such as an airline, a hotel, a rental car company, and the like.

In response to cardholder 220 entering into a travel-based transaction with merchant 230, transaction information of the travel-based transaction may be provided to payment processor 240 for authorization. For example, the payment processor 240 may be a processing entity such as MASTERCARD®, VISA®, AMERICAN EXPRESS®, and the like. Issuer 260 may be a third-party bank that issued a payment card to cardholder 220. For example, issuer 260 may correspond to payment processor 240. When cardholder 220 attempts to authorize a travel-based transaction using an account associated with a payment card issued by issuer 260, merchant 230 may transmit the travel-based transaction information to payment processor 240 to determine whether cardholder 220 has a sufficient amount of money in their account to cover the cost of the travel-based transaction. In response, payment processor 240 may verify with issuer 260 that cardholder 220 has sufficient funds.

The lifecycle of the transaction may include an authorization process, a clearing process, and a settlement process. During the authorization process, data for authorizing the transaction may be transmitted between merchant 230, payment processor 240, and issuer 260. For example, the authorization data may include a name, an account number, a transaction amount, a date and/or a time of the transaction, and the like. Here, the authorization data included in the authorization process may be only that data which is necessary to approve a transaction. Payment processor 240 may verify with the issuer 260 that cardholder 220 has sufficient funds in their account to cover a cost of the transaction.

When the transaction is approved by issuer 260, the issuer 260 may send notice of the approval to payment processor 240, which may in turn transmit the notice to merchant 230. This process typically occurs within a few seconds to a few minutes of the request to authorize the transaction. After the transaction has been authorized, the transaction may be forwarded to the payment processor 240 for settlement typically later that same day, week, and the like. The settlement process includes the money being transferred from a cardholder's bank to a merchant's bank. During settlement, prior to settlement, and/or after settlement, a clearing process occurs for the transaction. The clearing process typically includes arranging bank/credit accounts for transfer of money/securities. For example, the clearing process may include payment processor 240 validating information and approving the purchase information from the merchant 230. According to various aspects, during the clearing process, addendum data may be added to the transaction by the merchant 230, the payment processor 240, and the like. The clearing process may be completed after the authorization of the transaction is completed, for example, at the end of the same business day, one day later, two days later, and the like.

According to various exemplary aspects, travel analyzer 250 may analyze travel-based transactions that occur within the system 200. Here, the analyzer 250 may be coupled to or included within payment processor 240, within issuer 260, merchant 230, and the like. As another example, travel analyzer 250 may be a separate device connected to one or more of the other computing devices through network 210. Travel analyzer 250 may analyze transaction data from a travel-based transaction and extract travel-based information from the transaction. For example, travel analyzer 250 may analyze addendum data of the travel-based transaction to determine a travel destination of cardholder 220. Further, travel analyzer 250 may analyze historical transaction data including at least one of previous transaction data and addendum data of the current transaction, to determine a spending category to which the cardholder 220 belongs.

The addendum data may be added during a transaction lifecycle, for example, during the clearing process (if not included in the authorization process) and may include additional information about a transaction, one or more items purchased in the transaction, merchant information, cardholder information, and the like, which was not available during the authorization process. As another example, the addendum data may include information that was available during the authorization process but that was not processed during the authorization process. As yet another example, the addendum data may include information subsequently added to the transaction after the authorization process, and the like. Also, as described herein, transaction data may include authorization data and addendum data. In some examples, the authorization data and the addendum data may partially overlap, or not overlap at all. In some cases, the addendum data may be added, or partially added during the authorization process. As another example, the addendum data may be added after the authorization process.

Using the additional information included in the addendum data, the recommendation system may provide suggestions of merchants that are located at a travel destination of the cardholder. Accordingly, the recommendation of the merchants to the cardholder may be more targeted or geared towards the cardholder's interests, spending habits, and the like, based upon the additional information that is included in the addendum data.

### Example of Travel Analyzing Computing Device

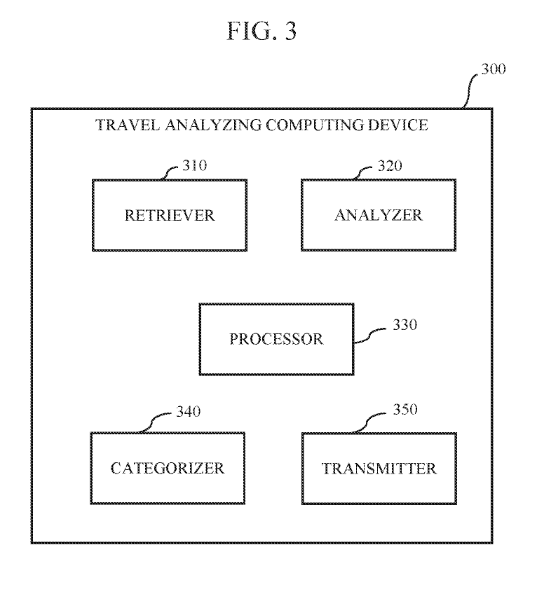

FIG. 3 is a diagram illustrating an example embodiment of a travel analyzing computing device that may be included in the recommendation system of FIG. 2, in accordance with an example embodiment of the present disclosure.

Referring to FIG. 3, travel analyzing computing device 300 may correspond to travel analyzer 250 shown in FIG. 2, and may be coupled to payment processor 240 or may be a separate computing device included in the system of FIG. 2, and may be connected to one or more of the other computing devices via the network 210. In this example, the travel analyzing computing device 300 includes a retriever 310, an analyzer 320, a processor 330, a categorizer 340, and a transmitter 350. The computing device 300 may include additional components not shown, or less than the amount of components shown. Also, one or more of the components in this example may be combined or may be replaced by processor 330. The computer components described herein (e.g., retriever 310; analyzer 320; processor 330; categorizer 340; and transmitter 350) may include hardware and/or software that are specially configured or programmed to perform the steps described herein.

Retriever 310 may obtain addendum data from transaction information included in a travel-based transaction of a cardholder. For example, the retriever 310 may receive the addendum data from another device, for example, a payment processor, a merchant, a bank, and the like, via one or more network connections, a direct connection, and the like. As another example, retriever 310 may retrieve data from a local storage (not shown) of computing device 300 or from another device. In some examples, in response to addendum data being added to a transaction, retriever 310 may automatically retrieve the addendum data, or the addendum data may be automatically transmitted to and received by retriever 310. Retriever 310 may also obtain other data besides addendum data. For example, retriever 310 may obtain authorization data, settlement data, and the like, of a travel-based transaction.

Based upon the addendum data from the travel-based transaction, spending information may be obtained. For example, analyzer 320 may analyze the addendum data and extract spending information of the cardholder based upon the addendum data. For example, the addendum data may include details about an airline purchase, a hotel booking, a car rental reservation, and the like. Accordingly, analyzer 320 may analyze the addendum data and extract spending information about the cardholder, for example, a type of hotel the cardholder has booked, a type of car the cardholder has reserved, passenger information about an airline ticket purchased by the cardholder, and the like. The extracted spending information may be stored in a data storage (not shown) of computing device 300. As another example, the extracted spending information may be transmitted to categorizer 340, and the like.

In addition to the spending information, travel information about an upcoming travel event or a current travel event of the cardholder may be extracted and/or determined. For example, analyzer 320 may analyze addendum data attached to a plane ticket, a hotel booking, a car rental reservation, and the like, and determine a travel destination of the cardholder. As a non-limiting example, the travel destination may be included in addendum data of an airline ticket, such as departure and arrival location information. As another example, the travel destination may be included in addendum data of a hotel booking, such as an address, a partial address (city, state, zip code, etc.), and the like about the hotel.

The addendum data analyzed by analyzer 320 may be added to the travel-based transaction during a clearing process of the travel-based transaction. In this example, the addendum data may include more granular details about the transaction and items purchased in the transaction than other transaction information such as authorization information.

Based upon spending data of the cardholder, a spending category of the cardholder may be determined. For example, categorizer 340 may determine a spending category of the cardholder, from among a plurality of previously determined spending categories, based upon the spending information extracted from the addendum data by analyzer 320. Categorizer 340 may also determine a spending category of the cardholder based upon previous transactions made by the cardholder in addition to or instead of the current transaction, for example, transactions made during a predetermined period of time such as during the last week, the last month, the last year, and the like. That is, the spending category determined by categorizer 340 may be based upon current transaction data and/or historical transaction data. Historical transaction data may include only travel-based transactions, any type of transactions, and the like. Also, examples of a spending category include, but are not limited to, business traveler, empty nester, young professional, single, married, family vacationer, corporate, and the like.

According to various aspects, categorizer 340 may compare the spending habits of the cardholder to spending habits of previously determined spending categories. In this case, the previously determined spending categories may be based upon the spending habits of, for example, all general cardholders, cardholders in a specific area, cardholders of a specific card type, and the like. That is, the spending categories may be based upon the spending habits of general users instead of particular types of users.

Processor 330 may recommend one or more merchants to the cardholder, for example, one or more merchants at the travel destination location. Accordingly, the merchants recommended by processor 330 may be based upon the travel destination and based upon the spending category of the cardholder. For example, if a cardholder is determined to be included in a corporate type spending category, processor 330 may recommend one or more merchants related to corporate entertainment, for example, a golf course, a restaurant, tickets to a ball game, and the like. Processor 330 may provide the recommendation of the merchants to the cardholder by controlling transmitter 350 to transmit merchant information, for example, in an e-mail, as a pop-up advertisement, as a telephone call, an instant SMS text message, and the like. As another example, processor 330 may store recommendations to a cardholder's account such that when the cardholder logs on to their account, such as through a website, information about the merchants may be displayed on a screen of the cardholder's device. In some examples, through transmitter 350, processor 330 may control a display of a cardholder computing device to display information about merchants located at a travel destination of the cardholder.

The merchants recommended to the cardholder may be based upon a popularity of the merchants with other cardholders that are included in the same spending category as a spending category of the cardholder. For example, the processor 330 may recommend merchants at the travel destination of the cardholder that have a predetermined popularity with other cardholders who are in the same spending category as the cardholder. As another example, the processor 330 may recommend a merchant at the travel destination that is most popular with a plurality of cardholders who are in the same spending category type as the spending category of the cardholder. Also, merchants may be recommended based upon other characteristics besides criteria. As another example, a merchant having a merchant type that corresponds to a spending category of the cardholder may be suggested to the cardholder. For example, if a cardholder is determined to be a cardholder with expensive spending habits, the processor 330 may recommend expensive restaurants to the cardholder. As another example, a merchant location may be considered when recommending merchants to the cardholder.

In some examples, the raw addendum data, the analyzed addendum data, the cardholder spending category, and the like, may be transmitted by the transmitter 350 of the travel analyzing computing device 300 to one or more merchants, third parties, and the like, for further processing. Accordingly, other entities besides the travel analyzing computing device 300 may provide the cardholder, or a computing device thereof, with recommendations of merchants and activities located at a travel destination of the cardholder. As a non-limiting example, the travel analyzing computing device 300 may be coupled to or may be included in a payment processor. The payment processor may transmit the analyzed addendum data and the cardholder spending category to a merchant, a third party website, and the like.

### Example of Cardholder Computing Device

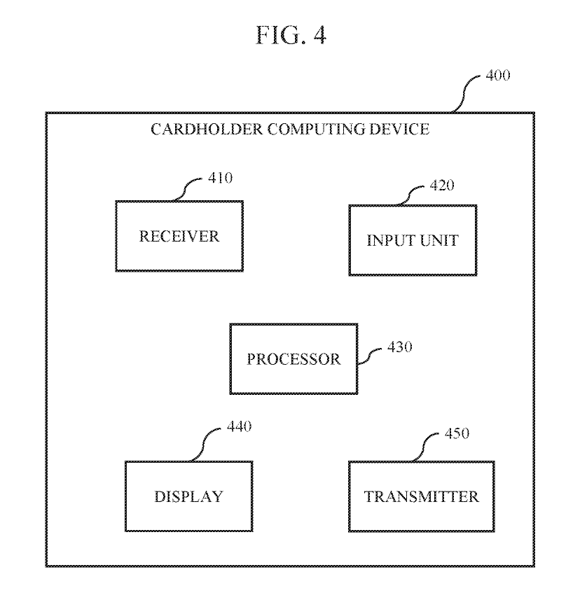

FIG. 4 is a diagram illustrating an example of a cardholder computing device that may be used by the customer included in the travel recommendation system of FIG. 1, in accordance with an example embodiment of the present disclosure.

Referring to FIG. 4, cardholder computing device 400 may be used by a cardholder to obtain or receive data about recommended merchants located at a future or current travel destination of the cardholder. In this example, the cardholder computing device 400 includes a receiver 410, an input unit 420, a processor 430, a display 440, and a transmitter 450. Cardholder computing device 400 may be, for example, a laptop computer, a mobile phone, a smart phone, a tablet, a desktop computer, an MP3 player, and the like. Also, although the different features are separately illustrated, one or more of the features may be omitted, combined with other features, and the like. For example, one or more of the features may be operated by or controlled by processor 430.

Cardholder may have an account/card that is provided by an issuing bank and that corresponds to a payment processor. Accordingly, when a cardholder makes a purchase, at least one of the issuing bank and the payment processor may be contacted by a merchant in order to process a transaction, such as a travel-based transaction. The cardholder may input their information to cardholder computing device 400 using input unit 420 and use cardholder computing device 400 to make a travel-based purchase.

As described in the example of FIG. 2, a cardholder may use cardholder computing device 400 to make a purchase from an online merchant. As another example, the cardholder may use cardholder computing device 400 to make a purchase over the phone, and the like. As an example, the cardholder may purchase at least one of an airplane ticket, a hotel booking, a rental car, and the like, through a website that is displayed on display 440 of cardholder computing device 400. Here, the cardholder may use input unit 420 to enter inputs into the website to make a purchase. For example, the input unit may include at least one of a keyboard, a mouse, a motion recognizer, a camera, a speech recognition module, and the like. Transmitter 450 may transmit a signal including purchase information to a merchant computing device. The merchant may transmit information about the purchase to a payment processor for authorization of the purchase.

In various examples, the merchant may receive an indication from the payment processor that indicates approval of the purchase made by the cardholder through the cardholder computing device 400. Subsequently, the transaction may go through a clearing process. During the clearing process, additional information may be added to the transaction, for example, addendum data about a travel-based transaction. According to various aspects, based upon the addendum data, a merchant, a payment processor, a third party, and the like may recommend merchants to the cardholder. For example, the recommended merchant information may be received by receiver 410 and displayed on display 440.

### Example of a Method for Providing Travel Recommendations

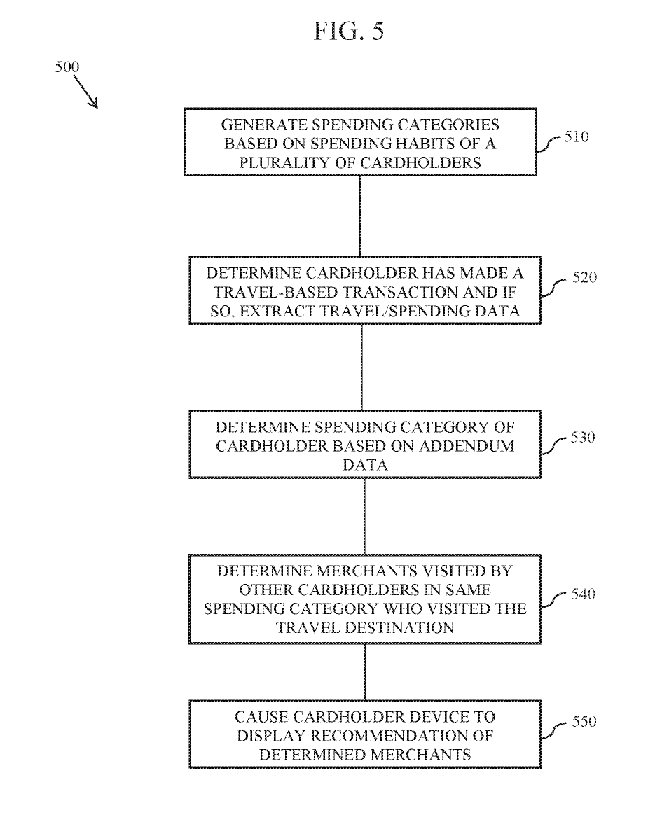

FIG. 5 is a diagram illustrating an example of a method 500 performed by travel analyzing computing device 300 when providing travel recommendations to a user, in accordance with an example embodiment of the present disclosure.

Referring to FIG. 5, illustrated is an example of a computer-implemented method 500 for recommending merchants at a travel destination of a traveling cardholder. For example, the method 500 may be implemented by the travel analyzing computing device 300 described in the example of FIG. 3. Method 500 includes generating 510 spending categories based upon spending habits of a plurality of cardholders. As described herein, travel analyzing computing device 300 has access to transaction information including addendum data of a transaction or addendum data of multiple transactions, and thus is able to generate spending information about a cardholder. The generated spending information may include a spending category of the cardholder indicating the spending habits of the cardholder. The travel analyzing computing device 300 may also determine or may store a plurality of spending categories of a plurality of cardholders. For example, based upon the general spending habits of all cardholders, a plurality of spending categories for the cardholders may be generated. Using historical transaction data of the traveling cardholder, the computing device may also determine a spending category of the traveling cardholder from among the stored plurality of spending categories. That is, the spending category of the traveling cardholder may be determined as the spending category from among the plurality of spending categories (based upon all cardholders) that most closely matches the spending habits of the traveling cardholder.

In addition to the authorization data of the transaction, the spending information may be based upon the addendum data which may be added to a transaction during the clearing process. The addendum data may include more granular data than what is included in the authorization data. As an example, the addendum data may include additional details about an item purchased by the transaction. Here, an item may refer to a good and/or a service. For example, an item may include a plane ticket, a rental car, a hotel booking, and the like.

To generate the spending categories, addendum data is retrieved from information included in a travel-based transaction of a cardholder. The addendum data may be obtained from a payment processor or a local storage of travel analyzing computing device 300. As another example, the addendum data may be received from an external device, such as a network connected device that is in communication with travel analyzing computing device 300. The retrieving may occur in response to a clearing process of the travel-based transaction being completed. The retrieved addendum data indicates the spending habits of the plurality of cardholders. Spending habits may include purchasing children's toys, eating at expensive restaurants and/or time of transactions. Based on the spending habits associated with the plurality of cardholders, spending categories are generated to encompass the type of spenders within the plurality of cardholders.

Method 500 further includes determining 520 that a cardholder has made a travel-based transaction, and if so, analyzing the addendum data and extracting travel and spending information of the traveling cardholder based upon the addendum data. For example, the addendum data may include an arrival city of a plane ticket added to an airline purchase transaction. As another example, the addendum data may include the address of a hotel booked by the cardholder and added to a hotel transaction. As another example, the addendum data may include a pickup location of a rental car that is added to a rental car transaction. Accordingly, a destination of travel of the cardholder may be determined based upon one or more pieces of addendum data included in the travel-based transaction.

Spending information about the cardholder may also be extracted from the addendum data and/or from previous transactions made by the cardholder. For example, the spending information may include an amount spent by the cardholder for an upcoming vacation, an amount previously spent by a cardholder while on vacation, and the like. Method 500 further includes determining 530 a spending category of the traveling cardholder, from among the plurality of spending categories, based upon the extracted spending information. The spending categories may be based upon the spending habits of the traveling cardholder in comparison to other cardholders.

In this example, method 500 further includes determining 540 merchants visited by other cardholders in the same spending category as the traveling cardholder and who have also visited the travel destination of the traveling cardholder. Thus, travel analyzing computing device 300 is configured to provide recommendations to the traveling cardholder based upon cardholders with the same or with similar spending habits as the traveling cardholder, instead of merely providing generalized recommendations to the traveling cardholder. These user-specific recommendations may be displayed on the cardholder device by travel analyzing computing device 300, which is configured to cause them to be displayed on said cardholder device.

Thus, method 500 further includes causing 550 the cardholder device to display recommendations of one or more merchants based upon the travel destination and the spending category of the cardholder. The recommendations may include recommending merchants at the travel destination that have a predetermined popularity with other cardholders who are in the same spending category as the traveling cardholder. As another example, the recommendations may include recommending a merchant at the travel destination that is most popular with a plurality of cardholders who are in the same spending category type as the spending category of the traveling cardholder.

As described herein, a cardholder does not necessarily require a card or an account with a card. For example, the cardholder may also be referred to as an account holder, a customer, and the like. Accordingly, a cardholder may simply have an account number without a card. Also, the cardholder may be required to input additional information, such as security credentials when using their card. As an example, and as is known to those skilled in the art, when a cardholder uses their account through a network, such as the Internet, a site at which they make a purchase may require additional details such as a PIN number, a social security number, an address, phone number, e-mail account, a CCV number, and the like, in order to authenticate or otherwise verify the account corresponds to the person making the purchase.

As will be appreciated based upon the foregoing specification, the above-described examples of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed examples of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

### Additional Considerations

The computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for recommending merchants at a travel destination to a cardholder. In this example, the computing device may include a memory device and a processor in communication with the memory device, and when executed by said processor, the computer-executable instructions may cause the processor to perform a method, such as the method described and illustrated in the example of FIG. 5.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. §112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A travel analyzing computing device comprising:
a retriever configured to obtain transaction data including addendum data from a travel-based transaction of a cardholder;
an analyzer configured to analyze the transaction data including the addendum data and extract a travel destination of the cardholder from the addendum data;
a categorizer configured to determine a spending category of the cardholder, from among a plurality of spending categories, based upon historical transaction data of the cardholder; and
a processor configured to recommend one or more merchants to the cardholder based upon the extracted travel destination and the determined spending category of the cardholder.

2. The travel analyzing computing device of claim 1, further comprising a transmitter configured to transmit information about the one or more recommended merchants to a computing device of the cardholder.

3. The travel analyzing computing device of claim 1, wherein the processor is configured to recommend merchants that have a predetermined popularity with other cardholders who are in the same spending category as the cardholder and who have traveled to the travel destination.

4. The travel analyzing computing device of claim 1, wherein the processor is configured to recommend a merchant that is most popular with a plurality of cardholders who are in the same spending category as the spending category of the cardholder and who have traveled to the travel destination.

5. The travel analyzing computing device of claim 1, wherein the plurality of spending categories comprise a business traveler spending category and a family vacationer spending category.

6. The travel analyzing computing device of claim 1, wherein the addendum data is added to the travel-based transaction during a clearing process of the travel-based transaction.

7. The travel analyzing computing device of claim 1, wherein the travel-based transaction comprises an airline ticket transaction and the addendum data comprises at least one of a flight destination, a flight number, a flight time, and a class of passenger seating on the flight.

8. The travel analyzing computing device of claim 1, wherein the travel-based transaction comprises a rental car transaction and the addendum data comprises at least one of a pickup and drop-off location, a miles driven record, an insurance type, a corporate flag, a tax exemption flag, and a rental class.

9. The travel analyzing computing device of claim 1, wherein the travel-based transaction comprises a hotel booking transaction and the addendum data comprises at least one of a hotel charge for a restaurant, a hotel charge for a bar, a hotel charge for a spa, a hotel charge for a fitness center, a hotel charge for a banquet hall, a hotel charge for a business center, and a hotel charge for a conference room.

10. The travel analyzing computing device of claim 1, wherein the retriever is configured to obtain the addendum data in response to a clearing process of the travel-based transaction being completed.

11. The travel analyzing computing device of claim 1, wherein the historical transaction data includes previous purchases of the cardholder and the obtained addendum data.

12. A computer-implemented method for recommending merchants located near a travel destination of a cardholder, the method being implemented by a travel analyzing computing device, the method comprising:
obtaining transaction data including addendum data from a travel-based transaction of a cardholder;
analyzing the addendum data and extracting a travel destination of the cardholder from the addendum data;
determining a spending category of the cardholder, from among a plurality of spending categories, based upon historical transaction data of the cardholder; and
recommending one or more merchants to the cardholder based upon the extracted travel destination and the determined spending category of the cardholder.

13. The method of claim 12, further comprising transmitting information about the one or more recommended merchants to a computing device of the cardholder.

14. The method of claim 12, wherein the recommending comprises recommending a merchant at the travel destination that has a predetermined popularity with other cardholders who are in the same spending category as the cardholder and who have traveled to the travel destination.

15. The method of claim 12, wherein the recommending comprises recommending a merchant at the travel destination that is most popular with a plurality of cardholders who are in the same spending category as the spending category of the cardholder and who have traveled to the travel destination.

16. The method of claim 12, wherein the plurality of spending categories comprise a business traveler spending category and a family vacationer spending category.

17. The method of claim 12, wherein the addendum data is added to the travel-based transaction during a clearing process of the travel-based transaction.

18. The method of claim 12, wherein the travel-based transaction comprises an airline ticket transaction and the addendum data comprises at least one of a flight destination, a flight number, a flight time, and a class of passenger seating on the flight.

19. The method of claim 12, wherein the travel-based transaction comprises a rental car transaction and the addendum data comprises at least one of a pickup and drop-off location, a miles driven record, an insurance type, a corporate flag, a tax exemption flag, and a rental class.

20. The method of claim 12, wherein the travel-based transaction comprises a hotel booking transaction and the addendum data comprises at least one of a hotel charge for a restaurant, a hotel charge for a bar, a hotel charge for a spa, a hotel charge for a fitness center, a hotel charge for a banquet hall, a hotel charge for a business center, and a hotel charge for a conference room.

21. The method of claim 12, wherein the retrieving occurs in response to a clearing process of the travel-based transaction being completed.

22. The method of claim 12, wherein the historical transaction data includes previous purchases of the cardholder and the obtained addendum data.

23. A non-transitory computer-readable storage media having computer-executable instructions embodied thereon, when executed by at least one processor, the computer-executable instructions cause the at least one processor to:
obtain transaction data including addendum data from a travel-based transaction of a cardholder;
analyze the addendum data and extract a travel destination of the cardholder from the addendum data;
determine a spending category of the cardholder, from among a plurality of spending categories, based upon historical transaction data of the cardholder; and
recommend one or more merchants based upon the extracted travel destination and the determined spending category of the cardholder.
